(19) United States
(12) Patent Application Publication
(10) Pub. No.: US 2009/0102786 A1
(43) Pub. Date: Apr. 23, 2009

(54) METHOD FOR TESTING AND PAIRING WIRELESS PERIPHERAL DEVICE

(75) Inventors: Chien-Nan Lin, Taipei (TW); Tsung-Wen Hsueh, Taipei (CN)

Correspondence Address: KIRTON AND MCCONKIE, 60 EAST SOUTH TEMPLE,, SUITE 1800, SALT LAKE CITY, UT, 84111, US

(73) Assignee: PRIMAX ELECTRONICS LTD., Taipei (TW)

(21) Appl. No.: 12/131,374

(22) Filed: Jun. 2, 2008

(30) Foreign Application Priority Data
Oct. 19, 2007 (TW) 096139112

(51) Int. Cl. G06F 3/048

(52) U.S. Cl. 345/156

(57) ABSTRACT

The present invention relates to a method for testing and pairing a wireless peripheral device. Different communication channels and different identification codes are used for testing and pairing the wireless peripheral device. As a result, the erroneous pairing relation the wireless input device and the wireless transceiver of the wireless peripheral device is avoided.

### FIELD OF THE INVENTION

The present invention relates to a method for testing and pairing a wireless peripheral device, and more particularly to a method for testing and pairing a wireless peripheral device in order to avoid erroneous pairing operations.

### BACKGROUND OF THE INVENTION

With increasing development of high technology industries, personal computers become indispensable in the present generation. Therefore, a variety of new high-tech products are brought forth and the old ones are weeded out soon. For example, the approach of connecting the peripheral devices with the personal computer has made great progress from wired communication technologies toward wireless communication technologies. Typically, a wireless peripheral device principally includes a wireless transceiver and a wireless input device. The wireless input device includes for example a wireless mouse, a wireless keyboard, a wireless joystick and the like. When a wireless peripheral device is operated, a corresponding wireless transceiver is connected to the universal serial bus (USB) port of the host computer. Therefore, the signals generated from the wireless input device can be transmitted to the corresponding wireless transceiver through a specified communication channel. For rendering wireless communication between the wireless input device and the wireless transceiver, the wireless input device and the wireless transceiver need to recognize each other. As a consequence, a pairing operation needs to be executed during the production of the wireless peripheral device.

FIG. 1 is a schematic diagram illustrating a simplified production line for testing and pairing a wireless peripheral device according to the prior art. The wireless peripheral device is for example a wireless mouse. The production line of FIG. 1 principally includes a first testing station 11, a second testing station 12 and a pairing station 13. The function of the wireless mouse 111 is tested in the first testing station 11. The first testing station 11 includes a first testing unit 112. The first testing unit 112 has a testing code 14 and a pairing button 114. The function of the wireless transceiver 121 is tested in the second testing station 12. The second testing station 12 includes a second testing unit 122. The second testing unit 122 also has a testing code 14 and a pairing button 124.

In the conventional wireless peripheral device, the wireless transceiver 121 has a testing code 14 and the wireless mouse 111 has a testing code 14 and a device identification code 15. For testing the function of the wireless mouse 111 in the first testing station 11, the operator needs to press down the pairing button 113 of the wireless mouse 111 and then the pairing button 114 of the first testing unit 112. As a result, the testing code 14 and the device identification code 15 will be transmitted from the wireless mouse 111 to the first testing unit 112 through a communication channel in a working band. After receiving the testing code 14 and the device identification code 15, the first testing unit 112 issues a first response signal 115 to the wireless mouse 111. The reception of the first response signal 115 by the wireless mouse 111 indicates that the function of the wireless mouse 111 is valid.

For testing the function of the wireless transceiver 121 in the second testing station 12, the operator needs to press down the pairing button 124 of the second testing unit 122 and then the pairing button 123 of the wireless transceiver 121. As a result, the testing code will be transmitted from the second testing unit 122 to the wireless transceiver 121 through a communication channel in a working band. After receiving the testing code 14, the wireless transceiver 121 issues a second response signal 125 to the second testing unit 122. The reception of the second response signal 125 by the second testing unit 122 indicates that the function of the wireless transceiver 121 is valid.

After the functions of the wireless mouse 111 and the wireless transceiver 121 has passed the above tests in the first testing station 11 and the second testing station 12, the wireless mouse 111 and the wireless transceiver 121 will be fed into the pairing station 13 to perform the pairing operation. For performing the pairing operation in the pairing station 13, the operator needs to press down the pairing button 113 of the wireless mouse 111 and then the pairing button 123 of the wireless transceiver 121. As a result, the testing code 14 and the device identification code 15 will be transmitted from the wireless mouse 111 to the wireless transceiver 121 through a communication channel in a working band. After receiving the testing code 14 and the device identification code 15, the wireless transceiver 121 issues a third response signal 131 to the wireless mouse 111. In addition, the testing code 14 originally stored in the wireless transceiver 121 is replaced with the device identification code 15. In addition, the wireless transceiver 121 is set to communicate with the wireless mouse 111 through a specified communication channel in a working band. After receiving the third response signal 131, the wireless mouse 111 is also set to communicate with the wireless transceiver 121 through the specified communication channel.

The above-mentioned method for testing and pairing a wireless peripheral device, however, still has some drawbacks. Since the working band and the testing code used in the first testing station 11, the second testing station 12 and the pairing station 13 are identical, the possibility of causing erroneous pairing operations is increased. For example, during the operator in the pairing station 13 of the production line has pressed down the pairing button 113 of the wireless mouse 111 and the pairing button 123 of the wireless transceiver 121, if the operator in the second testing station 12 simultaneously presses down the pairing button 124 of the second testing unit 122 and the pairing button of the wireless transceiver being tested in the second testing unit 122, the testing code 14 and the device identification code 15 issued from the wireless mouse 111 may be received by the tested wireless transceiver in the second testing station 12 through a communication channel in a working band. Similarly, if the operator in the pairing station 13 and the operator in the first testing station 11 respectively perform the paring operation and the testing operation at the same time, an erroneous pairing relation occurs between the wireless mouse 111 in the pairing station 13 and the first testing unit 112 in the first testing station 11. Alternatively, the erroneous pairing relation may occur between the wireless transceiver 121 in the pairing station 13 and the wireless mouse being tested in the first testing station 11.

Therefore, there is a need of providing an improved method for testing and pairing a wireless peripheral device to avoid erroneous pairing operations, thereby enhancing product yield and reliability.

### SUMMARY OF THE INVENTION

It is an object of the present invention to provide a method for testing and pairing a wireless peripheral device to avoid erroneous pairing operations, thereby enhancing product yield and reliability.

In accordance with an aspect of the present invention, there is provided a method for testing and pairing a wireless peripheral device for use in a production line of a wireless input device and a wireless transceiver. The wireless input device has a first testing code, a pairing identification code and a device identification code. The wireless transceiver has a second testing code and the pairing identification code. The method includes steps: (A) testing the function of the wireless input device in a first testing unit having the first testing code, and testing the function of the wireless transceiver in a second testing unit having the second testing code; and (B) establishing a pairing relation between the wireless input device and the wireless transceiver.

The step (A) includes sub-steps of: (A1) issuing the first testing code from the wireless input device to the first testing unit through a working band; (A2) issuing a first response signal from the first testing unit to the wireless input device after the first testing code is received by the first testing unit, wherein the function of the wireless input device is discriminated to be valid when the first response signal is received by the wireless input device; (A3) issuing the second testing code from the second testing unit to the wireless transceiver through a pairing channel; and (A4) issuing a second response signal from the wireless transceiver to the second testing unit after the second testing code is received by the wireless transceiver, wherein the function of the wireless transceiver is discriminated to be valid when the second response signal is received by the second testing unit.

The step (B) including sub-steps of: (B1) issuing the pairing identification code and the device identification code from the wireless input device to the wireless transceiver through the pairing channel; (B2) issuing a third response signal from the wireless transceiver to the wireless input device after the pairing identification code and the device identification code are received by the wireless transceiver, replacing the pairing identification code with the device identification code, and setting the wireless transceiver to communicate with the wireless input device through the working band; and (B3) setting the wireless input device to communicate with the wireless transceiver through the working band after the third response signal is received by the wireless input device, wherein the frequency of the pairing channel is beyond the working band.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic diagram illustrating a simplified production line for testing and pairing a wireless peripheral device according to the prior art;

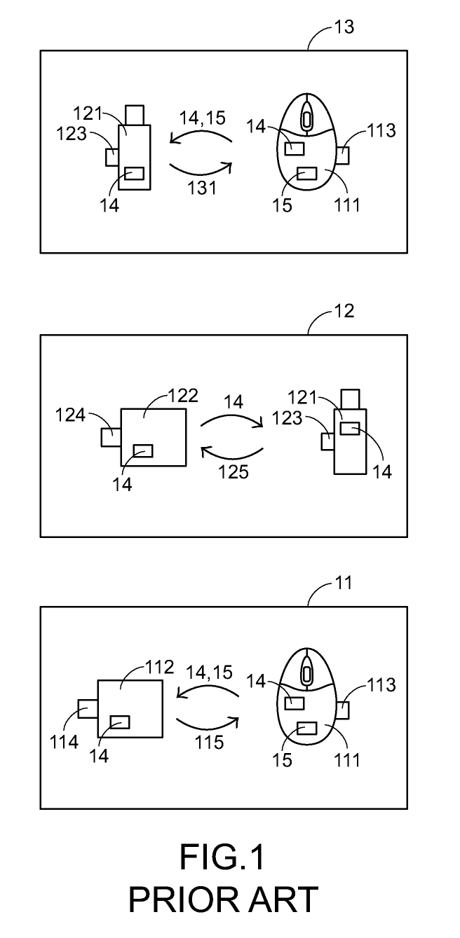

FIG. 2 is a schematic diagram illustrating a simplified production line for testing and pairing a wireless peripheral device according to a preferred embodiment of the present invention; and

FIG. 3 is a flowchart illustrating a method for testing and pairing a wireless peripheral device.

### DETAILED DESCRIPTION OF THE PREFERRED EMBODIMENT

The present invention relates to a method for testing and pairing a wireless peripheral device. The wireless peripheral device of the present invention includes a wireless transceiver and a wireless input device. An example of the wireless input device includes but is not limited to a wireless mouse, a wireless keyboard or a wireless joystick. In the present invention, a wireless mouse is used as an exemplary wireless input device for illustration.

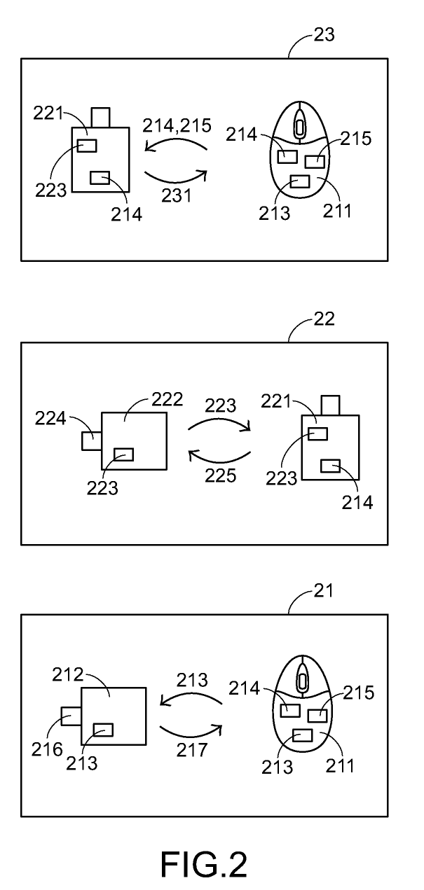

FIG. 2 is a schematic diagram illustrating a simplified production line for testing and pairing a wireless peripheral device according to a preferred embodiment of the present invention. The wireless peripheral device is for example a wireless mouse. The production line of FIG. 2 principally includes a first testing station 21, a second testing station 22 and a pairing station 23. The function of the wireless mouse 211 is tested in the first testing station 21. The first testing station 21 includes a first testing unit 212. The first testing unit 2112 has a first testing code 213 and a pairing button 216. The function of the wireless transceiver 221 is tested in the second testing station 22. The second testing station 22 includes a second testing unit 222. The second testing unit 222 also a second testing code 223 and a pairing button 224. In this embodiment, the wireless mouse 211 has the first testing code 213, a pairing identification code 214 and a device identification code 215. The wireless transceiver 221 has the second testing code 223 and the pairing identification code 214.

For testing the function of the wireless mouse 211 in the first testing station 211, the operator allows the wireless mouse 211 to issue the first testing code 213 and then presses down the pairing button 216 of the first testing unit 212. As a result, the first testing code 213 is transmitted from the wireless mouse 211 to the first testing unit 212 through a communication channel in a working band. In this embodiment, the frequency spectrum of the working band is ranged from 2,400 MHz to 2,483.5 MHz. The frequency of the communication channel may be for example 2,402 MHz, 2,426 MHz, 2,450 MHz, 2,474 MHz, 2,408 MHz, 2,432 MHz, 2,456 MHz, 2,414 MHz, 2,438 MHz, 2,462 MHz, 2,420 MHz, 2,444 MHz or 2,468 MHz.

After receiving the first testing code 213, the first testing unit 212 issues a first response signal 217 to the wireless mouse 211. The reception of the first response signal 217 by the wireless mouse 211 indicates that the function of the wireless mouse 211 is valid.

For testing the function of the wireless transceiver 221 in the second testing station 22, the operator needs to press down the pairing button 224 of the second testing unit 222 such that the second test code 223 is transmitted from the second testing unit 222 to the wireless transceiver 221 through a pairing channel. In accordance with a key feature of the present invention, the frequency of the pairing channel is beyond the frequency spectrum of the working band. For example, the frequency of the pairing channel may be 2,500 MHz. After receiving the second test code 223, the wireless transceiver 221 issues a second response signal 225 to the second testing unit 222. The reception of the second response signal 225 by the second testing unit 222 indicates that the function of the wireless transceiver 221 is valid.

After the functions of the wireless mouse 211 and the wireless transceiver 221 has passed the above tests in the first testing station 21 and the second testing station 22, the wireless mouse 211 and the wireless transceiver 221 will be fed into the pairing station 23 to perform the pairing operation. For performing the pairing operation in the pairing station 23, the operator allows the wireless mouse 211 to issue the pairing identification code 214 and the device identification code 215 to the wireless mouse 211 through the paring channel. Thus, the wireless mouse 211 waits for receiving the pairing identification code 214 and the device identification code 215. After receiving the pairing identification code 214 and the device identification code 215, the wireless mouse 211 issues a third response signal 231 to the wireless mouse 211. Meanwhile, the pairing identification code 214 originally stored in the wireless transceiver 221 is replaced with the device identification code 215. In addition, the wireless transceiver 221 is set to communicate with the wireless mouse 111 through a specified communication channel in the working band. After receiving the third response signal 231, the wireless mouse 211 is also set to communicate with the wireless transceiver 221 through the specified communication channel. Meanwhile, the wireless communication pairing between the wireless transceiver 221 and the wireless mouse 211 has been completed.

In comparison with the conventional testing and pairing method, the frequency of the pairing channel is beyond the frequency spectrum of the working band. In addition, the first testing code 213, the second testing code 223 and the pairing identification code 214 are used to execute the testing operation and the pairing operation. In other words, the present invention may avoid causing erroneous pairing relation between the wireless transceiver 221 and the wireless mouse 211 in the pairing station 23 and the wireless mouse tested in the first testing station 21 or the wireless transceiver tested in the second testing station 22. As a consequence, the product yield and reliability of the wireless peripheral device is enhanced.

For example, during the operator performs the pairing operation in the pairing station 23, if the operator in the second testing station 22 is testing the function of the wireless transceiver 221, no erroneous pairing relation will occur between the wireless transceiver 221 in the pairing station 23 and the second testing unit 222 in the second testing station 22. The reason is because the wireless mouse 211 in the pairing station 23 waits for receiving the pairing identification code 214 and the device identification code 215 but the second testing unit 222 in the second testing station 22 issues the second testing code 223. Similarly, since the wireless mouse 211 in the pairing station 23 issues the pairing identification code 214 and the device identification code 215 but the wireless transceiver tested in the second testing station 22 waits for receiving the second testing code 223, no erroneous pairing relation will occur between the wireless mouse 211 in the pairing station 23 and the wireless transceiver tested in the second testing station 22. Moreover, the data associated with the pairing operation in the pairing station 23 are transmitted through the pairing channel, but the data associated with the testing operation in the first testing station 21 are transmission through a communication channel of the working band. Since the frequency of the pairing channel is different from that of the communication channel, no erroneous pairing relation will occur between the components in the pairing station 23 and the components in the first testing station 21.

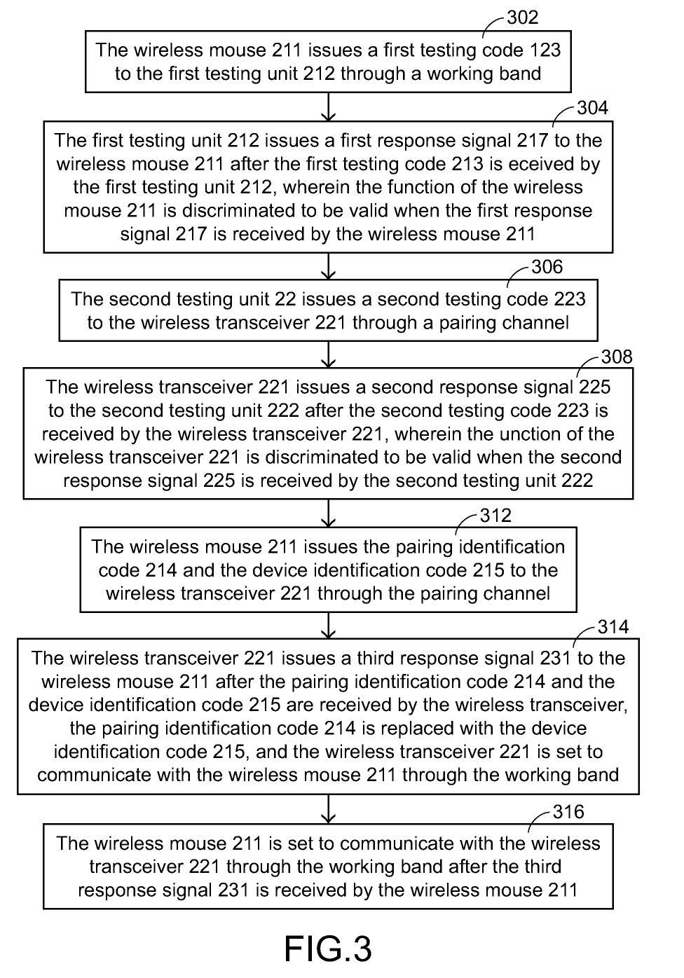

FIG. 3 is a flowchart illustrating a method for testing and pairing a wireless peripheral device. In the steps 302, 304, 306 and 308, the first testing unit 212 is used to test the function of the wireless mouse 211 and the second testing unit 222 is used to test the function of the wireless transceiver 221. In the steps 312, 314 and 316, the pairing relation between the wireless mouse 211 and the wireless transceiver 221 is established.

Hereinafter, the method for testing and pairing a wireless peripheral device according to the present invention will be illustrated in more details with reference to FIGS. 2 and 3.

In the step 302, the wireless mouse 211 issues a first testing code 123 to the first testing unit 212 through a working band. Next, in the step 304, the first testing unit 212 issues a first response signal 217 to the wireless mouse 211 after the first testing code 213 is received by the first testing unit 212, wherein the function of the wireless mouse 211 is discriminated to be valid when the first response signal 217 is received by the wireless mouse 211. Next, in the step 306, the second testing unit 22 issues a second testing code 223 to the wireless transceiver 221 through a pairing channel. Next, in the step 308, the wireless transceiver 221 issues a second response signal 225 to the second testing unit 222 after the second testing code 223 is received by the wireless transceiver 221, wherein the function of the wireless transceiver 221 is discriminated to be valid when the second response signal 225 is received by the second testing unit 222.

Next, in the step 312, the wireless mouse 211 issues the pairing identification code 214 and the device identification code 215 to the wireless transceiver 221 through the pairing channel. Next, in the step 314, the wireless transceiver 221 issues a third response signal 231 to the wireless mouse 211 after the pairing identification code 214 and the device identification code 215 are received by the wireless transceiver, the pairing identification code 214 is replaced with the device identification code 215, and the wireless transceiver 221 is set to communicate with the wireless mouse 211 through the working band. Next, in the step 316, the wireless mouse 211 is set to communicate with the wireless transceiver 221 through the working band after the third response signal 231 is received by the wireless mouse 211. Meanwhile, the wireless communication pairing between the wireless transceiver 221 and the wireless mouse 211 has been completed.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for testing and pairing a wireless peripheral device for use in a production line of a wireless input device and a wireless transceiver, said wireless input device having a first testing code, a pairing identification code and a device identification code, said wireless transceiver having a second testing code and said pairing identification code, said method comprising steps of:
(A) testing the function of said wireless input device in a first testing unit having said first testing code, and testing the function of said wireless transceiver in a second testing unit having said second testing code, said step (A) including sub-steps of:
(A1) issuing said first testing code from said wireless input device to said first testing unit through a working band;
(A2) issuing a first response signal from said first testing unit to said wireless input device after said first testing code is received by said first testing unit, wherein the function of said wireless input device is discriminated to be valid when said first response signal is received by said wireless input device;
(A3) issuing said second testing code from said second testing unit to said wireless transceiver through a pairing channel; and
(A4) issuing a second response signal from said wireless transceiver to said second testing unit after said second testing code is received by said wireless transceiver, wherein the function of said wireless transceiver is discriminated to be valid when said second response signal is received by said second testing unit; and
(B) establishing a pairing relation between said wireless input device and said wireless transceiver, said step (B) including sub-steps of:
(B1) issuing said pairing identification code and said device identification code from said wireless input device to said wireless transceiver through said pairing channel;
(B2) issuing a third response signal from said wireless transceiver to said wireless input device after said pairing identification code and said device identification code are received by said wireless transceiver, replacing said pairing identification code with said device identification code, and setting said wireless transceiver to communicate with said wireless input device through said working band; and
(B3) setting said wireless input device to communicate with said wireless transceiver through said working band after said third response signal is received by said wireless input device, wherein the frequency of said pairing channel is beyond said working band.

2. The method for testing and pairing a wireless peripheral device according to claim 1 wherein said wireless input device is a wireless mouse, a wireless keyboard or a wireless joystick.

3. The method for testing and pairing a wireless peripheral device according to claim 1 wherein the frequency spectrum of said working band is ranged from 2,400 MHz to 2,483.5 MHz.

4. The method for testing and pairing a wireless peripheral device according to claim 1 wherein said working band includes a plurality of communication channels, and the frequencies of said communication channels include 2,402 MHz, 2,426 MHz, 2,450 MHz, 2,474 MHz, 2,408 MHz, 2,432 MHz, 2,456 MHz, 2,414 MHz, 2,438 MHz, 2,462 MHz, 2,420 MHz, 2,444 MHz and 2,468 MHz.

5. The method for testing and pairing a wireless peripheral device according to claim 4 wherein in said step (A1), said first testing code is transmitted from said wireless input device to said first testing unit through one of said communication channels.

6. The method for testing and pairing a wireless peripheral device according to claim 4 wherein in said step (B3), said wireless input device communicates with said wireless transceiver through one of said communication channels.

7. The method for testing and pairing a wireless peripheral device according to claim 1 wherein the frequency of said pairing channel is 2,500 MHz.
